(19) United States
(12) Patent Application Publication
(10) Pub. No.: US 2023/0298064 A1
(43) Pub. Date: Sep. 21, 2023

(54) SYSTEMS AND METHODS FOR FACILITATING REDEMPTION OF UNIQUE DIGITAL ASSET UTILITY

(71) Applicant: SEEK XR, INC., Lehi, UT (US)

(72) Inventors: Jeremy Matthew Whitt, Boca Raton, FL (US); Jonathan R. Cheney, Payson, UT (US); Christoper Joshua White, Vineyard, UT (US); Taylan Ammon White, Lehi, UT (US)

(21) Appl. No.: 18/160,010

(22) Filed: Jan. 26, 2023

Related U.S. Application Data
(60) Provisional application No. 63/303,377, filed on Jan. 26, 2022.
(60) Provisional application No. 63/303,392, filed on Jan. 26, 2022.

(51) Int. Cl. G06Q 30/0207; G06Q 30/0211; G06Q 20/38

(52) U.S. Cl. CPC G06Q 30/0225; G06Q 20/389; G06Q 30/0211

(57) ABSTRACT

A system for facilitating redemption of unique digital asset utility is configurable to determine one or more redemption pathways for facilitating redemption of utility for a unique digital asset. The one or more redemption pathways comprise one or more redemption triggers and one or more redemption processes. The system is also configurable to, in response to detecting presence or performance of the one or more redemption triggers, facilitate the one or more redemption processes to cause redemption of the utility associated with the unique digital asset.

### CROSS-REFERENCE TO RELATED APPLICATIONS

This application claims priority to U.S. Provisional Application No. 63/303,377, filed Jan. 26, 2022, and entitled “SYSTEMS AND METHODS FOR FACILITATING REDEMPTION OF NON-FUNGIBLE TOKEN UTILITY”, and claims priority to U.S. Provisional Application No. 63/303,392, filed Jan. 26, 2022, and entitled “SYSTEMS AND METHODS FOR FACILITATING INTELLIGENT DISTRIBUTION OF ASSETS TO METAVERSES”, the entirety of which are incorporated herein by reference.

### BACKGROUND

A unique digital asset is a non-interchangeable and/or unique unit of data, which may be stored on a blockchain (e.g., a digital ledger) and/or in other formats. Unique digital assets may be associated with various types of content, such as digital content (e.g., audio files, image files, video files, etc.) or even physical assets. In some instances, a unique digital asset may be created via cryptographic transactions that create a digital signature for one or more digital files, and records of such transactions may be strung to previous records (e.g., on a blockchain). The digital signature may be used to track unique digital asset ownership, and a unique digital asset’s presence on a blockchain (or other digital ledger) may publicly establish ownership of the unique digital asset or certify the authenticity of the unique digital asset (although the unique digital asset’s presence on the blockchain does not necessarily restrict copying of underlying content associated with the unique digital asset).

unique digital assets have received significant attention from creators, collectors, and other entities associated with digital (and even physical) assets. However, existing processes associated with creating (minting) unique digital assets, marketing unique digital assets, exchanging/purchasing unique digital assets, and/or performing/enforcing obligations related to unique digital assets are cumbersome, inefficient, and/or highly specialized. Such challenges present a barrier to entry for many would-be creators, collectors, and/or other entities associated with unique digital assets.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore considered to be limiting in scope, embodiments will be described and explained with additional specificity and detail through the use of the accompanying drawings in which:

FIG. 1 illustrates a conceptual representation of various components of an example utility engine for facilitating managing, monitoring, and/or measuring redemption of utility associated with unique digital assets.

FIG. 2 illustrates a conceptual representation of an example digital asset ecosystem where a utility engine can be implemented.

FIGS. 3 and 4 illustrate example flow diagrams depicting acts associated with facilitating redemption of utility of unique digital assets.

FIG. 5 depicts example components of a system that may comprise or be configurable to perform various embodiments.

### DETAILED DESCRIPTION

Disclosed embodiments relate to a unique digital asset utility engine that may select and implement an appropriate redemption pathway to facilitate redemption of a benefit or utility associated with a unique digital asset (e.g., for the benefit of one or more beneficiaries).

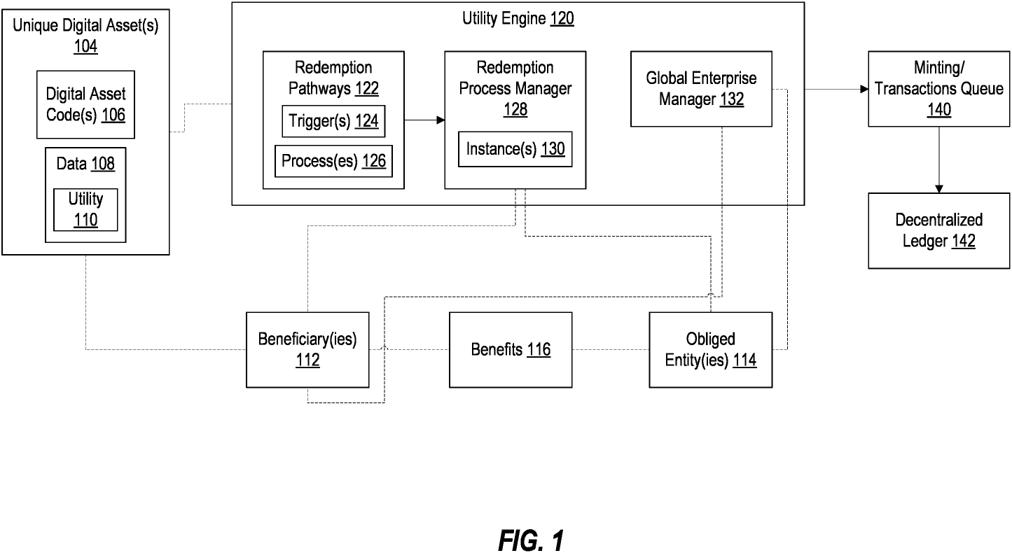

FIG. 1 illustrates a conceptual representation of various components of a utility engine for facilitating managing, monitoring, and/or measuring redemption of utility associated with unique digital assets. FIG. 1 depicts unique digital asset(s) 104, which, as noted hereinabove may take on various forms (e.g., the form of a non-fungible token (NFT) or other form). For instance, unique digital asset(s) 104 may comprise or be associated with digital asset code(s) 106, which may be generally analogous to uniform product codes (UPCs), global trade item numbers (GTINs), and/or other types of identifiers (e.g., a digital asset identifier or token that is globally unique for any digital asset, analogous to a serial number). In this regard, digital asset code(s) 106 may uniquely identify digital asset traits and distinguish them from other types of digital assets. In some instances, unique digital asset(s) 104 may be associated with a respective primary key to facilitate indexing of unique types of digital asset(s) 104 in a database or list of unique types of digital assets 104. In some instances, a digital asset code 106 of a unique digital asset 104 may be used as a primary key for the type of unique digital asset 104.

Unique digital asset(s) 104 may comprise or be associated with data 108 defining protocols related to transfer/conveyance of the unique digital asset(s) 104 and/or other aspects of the unique digital asset 104 (e.g., in the form of a smart contract or other data that may be stored in association with the digital asset code 106 of a unique digital asset 104, such as within a database or list of unique digital assets). Such data 108 may define utility 110 for beneficiary(ies) 112 of the unique digital asset(s) 104. Beneficiary(ies) 112 may comprise owners of unique digital asset(s) 104 and/or one or more entities that may be benefitted by the unique digital asset(s) 104. The association between the beneficiary(ies) 112 and the unique digital asset(s) 104 is depicted in FIG. 1 with a dashed line.

Utility 110 associated with unique digital asset(s) 104 may take on various forms. By way of illustrative example, utility 110 may comprise one or more assets (e.g., physical or digital), services, statuses, abilities, privileges, states, and/or other benefits, without limitation, that the beneficiary(ies) 112 is/are eligible/able to receive as indicated by the data 108 defining the utility 110. By way of illustrative, non-limiting example, utility 110 may take the form of access ticketing, eCommerce fulfillment, payment transactions, unlocking of functionality/access, raffling, etc.

In view of the multitude of possible forms of utility 110, numerous possibilities also exist for the manner in which utility 110 may be redeemed for the benefit of the beneficiary(ies) 112. Such alternative modes, avenues, or methods (e.g., sets of steps) for redeeming utility 110 associated with an unique digital asset may be regarded as redemption pathways.

In accordance with the present disclosure, a utility engine 120 may be utilized to facilitate desired redemption of unique digital asset utility in accordance with an appropriate redemption pathway. For instance, as depicted in FIG. 1, a utility engine 120 may comprise or access the data 108 defining the utility 110 of unique digital asset(s) 104 (e.g., by accessing the database or list of unique digital assets 104, which may store the data 108 for the unique digital asset(s) 104). Based upon the data 108 for the unique digital asset(s) 104, the utility engine 120 may determine a redemption protocol for the unique digital asset(s) 104.

The data 108 defining the utility 110 may comprise or utilize a taxonomy, data type definition, application program interface (API), or other structure to facilitate appropriate interpretation of the data 108 by the utility engine 120. regarding some instances, the utility 110 for a unique digital asset 104 may be defined in a manner that is stateless. Put differently, the utility 110 for a unique digital asset 104 may be defined in such a manner that is agnostic toward other aspects of the unique digital asset 104 (e.g., the particular blockchain in use, the type of currency usable to purchase the unique digital asset 104, alienability aspects of the unique digital asset 104, etc.).

The utility engine 120 may comprise or have access to a set of redemption pathways 122 (e.g., with different redemption pathways 122 defined for different unique digital assets 104 and/or utility 110 defined therefor). In some instances, each of the redemption pathways 122 is associated with a respective redemption trigger 124 and/or redemption process 126.

A redemption trigger 124 may comprise any event configured to initiate or activate conveyance or provision of the utility 110 associated with the unique digital asset(s) 104 to the beneficiary(ies) 112 (e.g., as indicated by the data 108 associated with the unique digital asset(s) 104). A redemption trigger 124 may comprise an action or command (e.g., user input at a device) initiated by the beneficiary(ies) 112 and/or one or more other entities, such as a creator of the unique digital asset(s) 104, entities obligated to perform according to data 108, and/or others. Various forms of a redemption trigger 124 are within the scope of the present disclosure, without limitation (e.g., navigating to a website or link, completing an authentication process, visiting a physical and/or virtual location, scanning of a scannable element such as a QR code, elapsing of a predetermined time period, and/or others).

A redemption process 126 of a redemption pathway 122 comprises one or more operations, transactions, interaction, acts, and/or performances (which may be conditioned on one another) associated with facilitating conveyance or provision of the utility 110 defined by the data 108 of the unique digital asset(s) 104 to the beneficiary(ies) 112. Such acts may include, by way of non-limiting example, notifying obliged entity(ies) 114 that a beneficiary desires to redeem utility associated with an unique digital asset, directing the beneficiary(ies) 112 to perform certain actions (e.g., to go to a certain physical/virtual location, furnish/present authenticating or other information or otherwise comply with security/legal/other protocols, scan scannable elements, respond to prompts, etc.), communicating beneficiary actions and/or information to the obliged entity(ies) 114 (and/or others), directing the obliged entity(ies) 114 to perform certain actions (e.g., to respond to prompts, provide products or services to beneficiary, modify a state or status associated with the beneficiary, grant the beneficiary access to certain content/locations, etc.), communicating obliged entity actions and/or information to the beneficiary(ies) 112, notifying one or more entities that utility redemption is complete, confirming performance by one or more parties, and/or other acts, without limitation.

The obliged entity(ies) 114 may comprise any party or parties with obligations defined by the data of the unique digital asset(s) 104 and/or fulfillment of the utility 110 for the benefit of the beneficiary(ies) 112 (e.g., a creator, sponsor, seller, and/or other entity associated with the unique digital asset 104 and/or the utility 110 thereof).

The redemption process(es) 126 of the redemption pathways 122 may, in some instances, be regarded as a set of inter-linked steps, where each step may comprise any number of child steps (e.g., next steps) and/or parent steps (e.g., previous steps) associated therewith. In some instances, the redemption trigger(s) 124 are first step(s) associated with corresponding redemption process(es) 126 (e.g., redemption triggers may be regarded as root steps or parent steps of or for the redemption process(es) 126. Any number of unique digital assets 104 may be conveyed/transferred to beneficiary(ies) 112, transferred to fulfillment containers (e.g., wallets), and/or otherwise transformed/transferred/activated as defined by data associated with the corresponding redemption pathway 122 (and/or data associated with the redemption process(es) 126 and/or particular steps/acts thereof).

The redemption pathways 122 (and/or the data 108) may define additional or alternative aspects, conditions, and/or constraints associated with the redemption of unique digital asset utility, without limitation (e.g., a permitted number of redemptions, a time period within which redemption is permitted, a location in which redemption is permitted, compliance conditions for redemption (e.g., geolocation, age, etc.) and/or others).

In view of the foregoing, based upon the utility 110 defined for unique digital asset(s) 104 (and/or other aspects of the unique digital asset(s) 104, such as digital asset code(s) 106 and/or other information), the utility engine 120 may determine an appropriate redemption pathway 122 that may be applied to facilitate conveyance and/or provision of the utility 110 to the beneficiary(ies) 112. For example, where the unique digital asset utility 110 amounts to a physical product and/or service being furnished to the beneficiary(ies) 112 upon demand, a particular redemption pathway 122 that includes steps (e.g., redemption process(es) 126) configured to facilitate such a transaction may be selected. As another example, where the unique digital asset utility 110 amounts to granting the beneficiary(ies) 112 access to certain physical or virtual locations, the selected redemption pathway 122 may include steps and/or process(es) 126 tailored to fulfilling such an end.

In some instances, additional inputs may be utilized by the utility engine 120 to determine an appropriate redemption pathway 122, such as user input, user profile/account information, etc. (e.g., selecting or defining a preferred or default redemption pathway from a plurality of available or applicable redemption pathways, constraining certain preferences related to unique digital asset redemption, etc.).

As shown in FIG. 1, the utility engine 120 may further comprise or be in communication with a redemption process manager 128. In some implementations, the redemption process manager 128 is configured to manage redemption instance(s) 130, which may comprise particular performances of redemptions of particular utility 110 associated with a unique digital asset 104 in accordance with a particular redemption pathway 122 (e.g., set of steps or template) for the particular utility 110.

The redemption process manager 128 may be configured to manage performance, progress, and/or completion of the one or more operations, transactions, interactions, acts, etc. associated with redemption instance(s) 130 of a redemption pathway 122 (e.g., trigger(s) 124 and/or process(es) 126) selected for utility 110 of unique digital asset(s) 104. In some instances, the redemption instance(s) 130 may be regarded as stateful (e.g., affected/contextualized by previous acts/transactions).

For example, based upon a particular redemption pathway 122 being selected by the utility engine 120 for redemption of particular utility 110 of a particular unique digital asset 104, and/or in response to a redemption trigger 124 of the redemption pathway 122 being detected, the redemption process manager 128 may facilitate a redemption instance 130 by providing prompts, direction, and/or other communications to the beneficiary(ies) 112 and/or obliged entity(ies) 114 to cause the beneficiary(ies) 112 and/or obliged entity(ies) 114 to perform acts (e.g., the process(es) 126 of the redemption pathway 122) pursuant to redemption of benefits 116 (defined by the data 108) to the beneficiary(ies) 112 (as indicated in FIG. 1 by the dashed lines extending among the redemption process manager 128, the beneficiary(ies) 112, the obliged entity(ies) 114, and the benefit 116).

The redemption process manager 128 may additionally or alternatively be configured to receive data and/or other communications/information from beneficiary(ies) 112 and/or obliged entity(ies) 114 to obtain/record completed redemption steps (e.g., process(es 126) of a redemption pathway 122 and/or to obtain/record count data and/or time data associated with redemption instance(s) 130. Count data may indicate a quantity associated with redeemable utility 110 for a unique digital asset 104 (e.g., a quantity of digital asset codes that are or have been redeemed). Time data may enable sorting and/or organizing of redemption data (e.g., completed trigger(s) 124, process(es) 126, and/or other acts/information associated with utility redemption) in a logical order (e.g., within a respective hierarchy of active and/or completed process(es) 126 defined by the applicable redemption pathway 122).

The redemption process manager 128 may be configured to send executable instructions and/or data/information to one or more devices associated with the beneficiary(ies) 112 and/or the obliged entity(ies) 114, which may cause the devices to perform functions (and/or enable human users to participate in the fulfillment of functions) related to the redemption of the unique digital asset utility.

In some instances, to facilitate interaction between the utility engine 120 and the obliged entity(ies) 114 (and/or beneficiary(ies) 112) for the purpose of redeeming the utility 110, the obliged entity(ies) 114 may be provided with embed code to advantageously facilitate seamless interaction between the utility engine 120 and enterprise software, web services, and/or other tools associated with obliged entity(ies) 114. Such embed code may be implemented by obliged entity(ies) 114, for example, at point of sale locations (physical or virtual), websites, etc.

In some implementations, information related to redemption of benefits/utility of unique digital assets is tracked and/or managed utilizing a global enterprise manager 132 of the utility engine 120. In some instances, the global enterprise manager 132 is configured to obtain various metrics related to the redemption of unique digital assets, such as quantity/amount/character/cost of benefits redeemed, frequency of redemption, duration of redemption process, duration between availability of benefit to beneficiary and redemption of benefit, unredeemed benefits, and/or others.

The information associated with a global enterprise manager 132 may be gathered/formatted according to various paradigms, such as from a beneficiary paradigm, a creator paradigm, a sponsor paradigm, an obliged entity paradigm, etc. Such information may be gathered and/or presented for various purposes, such as to provide beneficiaries with mechanisms to track high-level benefits associated with the redemption of unique digital asset utility (e.g., similar to credit card or airline points systems), to provide organizations with marketing/incentive tools (e.g., an ability to indicate to users that a redeemed unique digital asset utility is part of a set of multiple unique digital asset utilities, incentivizing the beneficiary to acquire other unique digital assets to complete the set), gamification, etc. Various types of reports and/or other data tools may be generated by the global enterprise manager based on the information gathered thereby. Such reports and/or data tools may be provided to creators, sponsors, obliged entities, and/or other entities.

Any of the acts, performances, and/or operations (and/or modules/components, applications, and/or systems/devices configured to execute such acts, performances, and/or operations) associated with redemption of utility of unique digital assets described herein may be managed, facilitated, and/or tracked utilizing centralized systems/methodologies, decentralized systems/methodologies, or a combination thereof. For instance, in some embodiments, at least some of the operations discussed herein of the utility engine 120 are performed using one or more centralized systems (e.g., using local machines/nodes and/or distributed machines nodes, such as within a cloud computing infrastructure). Performing such operations on centralized system(s) (e.g., off-chain or off-ledger systems) can achieve high performance, speed, and/or reliability as compared to relying on decentralized systems (e.g., blockchain or decentralized ledger systems) to perform such operations. Utilizing centralized system(s) for such operations may additionally or alternatively reduce congestion issues that can arise in decentralized systems.

In some implementations, where at least some utility engine 120 operations are performed using at least partially centralized systems/methodologies, data/information recorded pursuant to performance of operations of the utility engine 120 (e.g., recorded data associated with active redemption pathways 122, progress or completion or count/time data of redemption steps and/or process(es) 126 of redemption instance(s) 130, etc.) can be enqueued in a minting/transactions queue 140. From the minting/transactions queue 140, the data/information associated with performance of operations of the utility engine 120 may be regularly recorded to a decentralized ledger 142 (e.g., a blockchain). The minting/transactions queue 140 may thus be regarded as a centralized ledger that regularly updates to a decentralized ledger to facilitate lazy minting of utility redemption transactions for unique digital assets.

In some instances, by utilizing a minting/transactions queue 140 as discussed, the benefits of both centralized systems (e.g., high performance, speed, reliability, reduced congestion, etc.) and decentralized systems (e.g., trustless visibility, verification, and/or archival) may be achieved for redemption of utility associated with unique digital assets (and/or other operations). Such functionality may enable blockchain platforms to reliably operate in heavy load and/or high demand implementations.

The data/information of a minting/transactions queue 140 may be batched (e.g., based on time information and/or other grouping schemes) to facilitate batched recording on the decentralized ledger 142. Recording from the minting/transactions queue 140 to the decentralized ledger 142 may be performed according to any suitable schedule (e.g., using predetermined time intervals, in response to receiving a threshold number of data/information entries and/or batches, etc.)

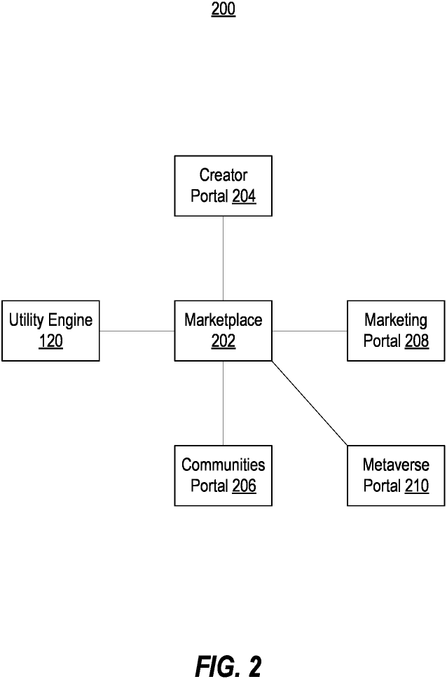

A utility engine as described herein may be implemented within the context of a digital asset ecosystem. FIG. 2 shows an example digital asset ecosystem 200 where the utility engine 120 can be implemented. The utility engine 120 can be implemented as a cloud computing construct (e.g., a software as a service (SaaS) solution) and can be made available to requesting entities of the digital asset ecosystem 200.

The digital asset ecosystem 200 is depicted in FIG. 2 as having a number of different discrete user touchpoints or portals with an interconnecting marketplace 202. The marketplace 202 may comprise logic, modules, and/or executable components for facilitating interoperation of the various components of the digital asset ecosystem 200.

One portal of the digital asset ecosystem 200 is a creator portal 204, whereby users (e.g., artists, teams, athletes, brands, organizations) are able to create unique digital assets. In some instances, creation of a unique digital asset via the creator portal 204 involves utilizing a blockchain platform to mint the created digital asset.

Another portal of the digital asset ecosystem is a communities portal 206, which may allow users (e.g., collectors, fans, brokers) to buy, trade, and/or store unique digital assets (e.g., unique digital assets created via the creator portal 204 and put into the marketplace 202). The communities portal 206 may, in some instances, comprise or communicate with user wallets to facilitate storage of acquired unique digital assets.

Another portal is a marketing portal 208, which may allow users (e.g., artists, teams, athletes, brands, organizations) to market unique digital assets to potential consumers (e.g., unique digital assets that are created via the creator portal 204). In some instances, the marketing portal 208 includes one or more websites and/or other marketing channels, which may include embed code to facilitate interoperation with the utility engine 120.

Another portal is the metaverse portal 210, which may include or be in communication with logic and/or engines used to deploy unique digital assets (and/or utility associated therewith) to one or more metaverses.

The utility engine 120 may be utilized to facilitate redemption of utility associated with unique digital assets that are conveyed, traded, sold, and/or otherwise transferred within the digital asset ecosystem (e.g., over the marketplace 202). One will appreciate, in view of the present disclosure, that redemption of utility of unique digital assets may involve actions, transformations, deployments, performances, and/or operations within the real world and/or within one or more metaverses. Furthermore, as noted hereinabove, records associated with redemption of utility of unique digital assets may be recorded into a decentralized ledger (e.g., utilizing a minting/transactions queue, as discussed herein).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

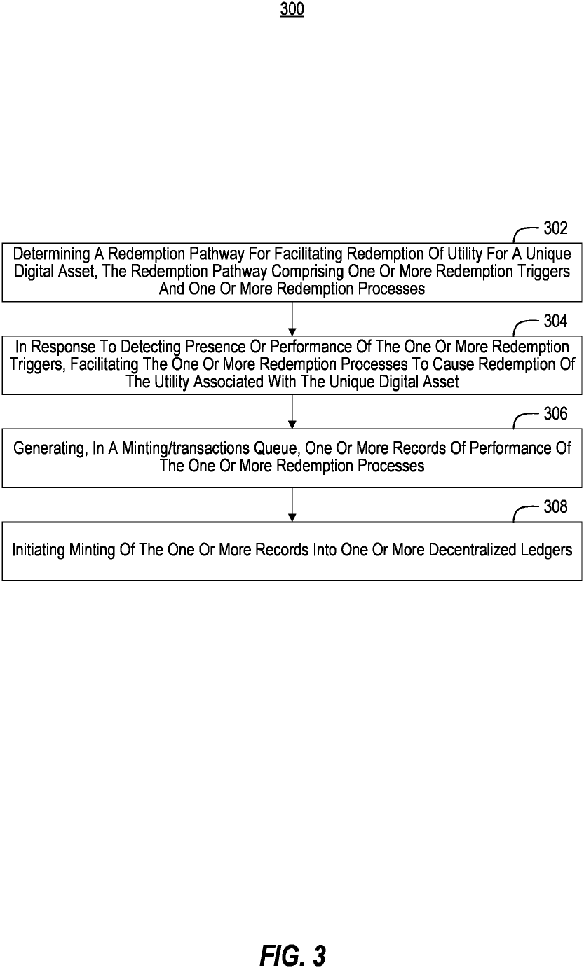

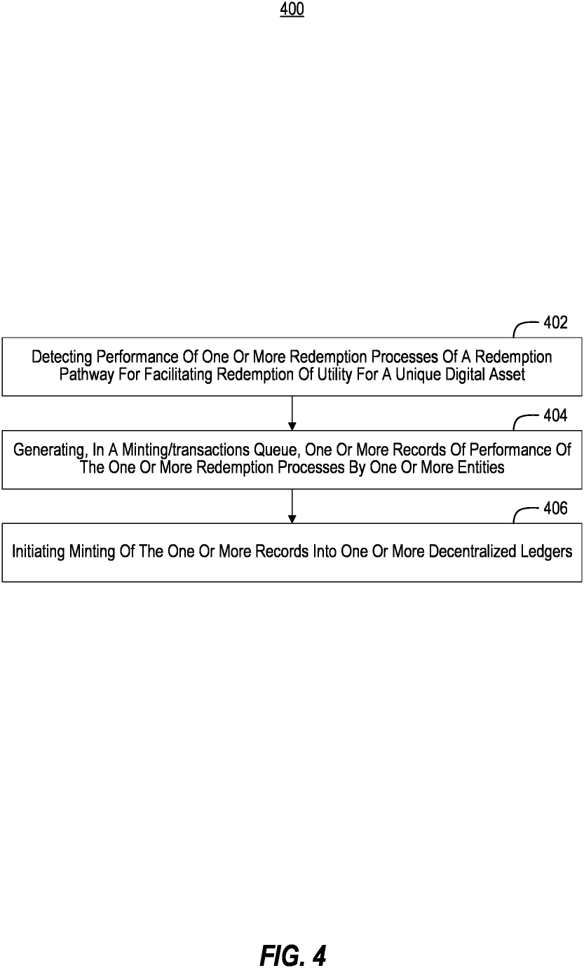

FIGS. 3 and 4 illustrate example flow diagrams 300 and 400, respectively, depicting acts associated with facilitating redemption of utility of unique digital assets. The acts depicted may be performed utilizing a utility engine 120 and/or other components described herein.

Act 302 of flow diagram 300 of FIG. 3 includes determining a redemption pathway for facilitating redemption of utility for a unique digital asset, the redemption pathway comprising one or more redemption triggers and one or more redemption processes. In some instances, the unique digital asset comprises a non-fungible token, but the unique digital asset may take on other forms in accordance with the present disclosure.

In some examples, the utility for the unique digital asset comprises providing one or more physical assets, digital assets, services, statuses, abilities, privileges, or states to one or more beneficiaries. The one or more beneficiaries may comprise one or more owners of the unique digital asset.

In some implementations, the redemption pathway is selected from a set of predetermined redemption pathways. The redemption pathway may comprise a set of inter-linked steps with one or more parent-child relationships among the set of inter-linked steps. In some instances, the one or more redemption triggers of the redemption pathway comprise one or more root steps of the set of inter-linked steps, and the one or more redemption processes of the redemption pathway comprise one or more additional steps of the set of inter-linked steps.

In some instances, the unique digital asset is associated with a digital asset code. The redemption pathway may be determined based upon the digital asset code. In some instances, the utility for the unique digital asset is first determined, and the redemption pathway is determined based upon the utility for the unique digital asset. In some implementations, the utility for the unique digital asset is defined by data associated with the unique digital asset in accordance with a predetermined data type definition.

Act 304 of flow diagram 300 includes, in response to detecting presence or performance of the one or more redemption triggers, facilitating the one or more redemption processes to cause redemption of the utility associated with the unique digital asset. In some implementations, facilitating the one or more redemption processes comprises managing a redemption instance. The redemption instance may comprise communicating the one or more redemption processes to one or more entities and/or tracking performance of the one or more redemption processes by the one or more entities.

Act 306 of flow diagram 300 includes generating, in a minting/transactions queue, one or more records of performance of the one or more redemption processes. Act 308 of flow diagram 300 includes initiating minting of the one or more records into one or more decentralized ledgers. In some instances, the one or more records of performance of the one or more redemption processes become part of a batch of records of performance of redemption processes associated with utility for one or more other unique digital assets. In some implementations, initiating minting of the one or more records into the one or more decentralized ledgers includes initiating minting of the batch or records. Minting may be initiated for batches of records in accordance with various schedules/schema (e.g., time-based, batch size-based, etc.).

In some instances, one or more of the acts of flow diagram 300 are performed by one or more centralized systems (e.g., system(s) that is/are not decentralized), whereas the minting of the one or more records (and/or the batch of records) is performed by one or more decentralized systems (e.g., in a trustless system) that is/are operationally and/or otherwise distinct from the one or more centralized systems.

Act 402 of flow diagram 400 of FIG. 4 includes detecting performance of one or more redemption processes of a redemption pathway for facilitating redemption of utility for a unique digital asset. In some implementations, the unique digital asset comprises a non-fungible token. In some instances, the utility for the unique digital asset comprises providing one or more physical assets, digital assets, services, statuses, abilities, privileges, or states to one or more beneficiaries. The one or more beneficiaries may comprise one or more owners of the unique digital asset.

In some examples, the redemption pathway is selected from a set of predetermined redemption pathways. In some instances, the redemption pathway comprises a set of inter-linked steps with one or more parent-child relationships among the set of inter-linked steps.

Act 404 of flow diagram 400 includes generating, in a minting/transactions queue, one or more records of performance of the one or more redemption processes by one or more entities. Act 406 of flow diagram 400 includes initiating minting of the one or more records into one or more decentralized ledgers.

In some instances, the one or more records of performance of the one or more redemption processes become part of a batch of records of performance of redemption processes associated with utility for one or more other/additional unique digital assets. In some implementations, initiating minting of the one or more records into the one or more decentralized ledgers includes initiating minting of the batch or records. Minting may be initiated for batches of records in accordance with various schedules/schema (e.g., time-based, batch size-based, etc.).

In some instances, one or more of the acts of flow diagram 400 are performed by one or more centralized systems (e.g., system(s) that is/are not decentralized), whereas the minting of the one or more records (and/or the batch of records) is performed by one or more decentralized systems (e.g., in a trustless system) that is/are operationally and/or otherwise distinct from the one or more centralized systems.

A utility engine 120 (and/or components thereof) may take on various forms, such as that of one or more software applications, executable modules/components, systems/devices, etc. As used herein, the terms “executable module,” “executable component,” “component,” “module,” or “engine” can refer to any combination of hardware components or software objects, routines, or methods that may configure a system/device to carry out certain acts. For instance, the different components, modules, engines, devices, and/or services described herein may be implemented utilizing one or more objects or processors that execute on one or more computer systems (e.g., as separate threads). While independent modules are depicted herein (e.g., redemption process manager 128, global enterprise manager 132), one will understand the characterization of a module is at least somewhat arbitrary. In at least one implementation, the various modules discussed herein may be combined, divided, or excluded in configurations other than that which is shown. For example, any of the functions described herein with reference to any particular module may be performed utilizing any number and/or combination of processing units, software objects, modules, instructions, computing centers, cloud resources, etc. As used herein, the individual modules are distinguished from one another for the sake of clarity and explanation, and such distinctions are not intended to be limiting.

The principles disclosed herein may be implemented in various formats. For example, the various techniques discussed herein may be performed as a method that includes various acts for achieving particular results or benefits. In some instances, the techniques discussed herein are represented in computer-executable instructions that may be stored on one or more hardware storage devices. The computer-executable instructions may be executable by one or more processors to carry out (or to configure a system to carry out) the disclosed techniques. In some embodiments, a system may be configured to send the computer-executable instructions to a remote device to configure the remote device for carrying out the disclosed techniques.

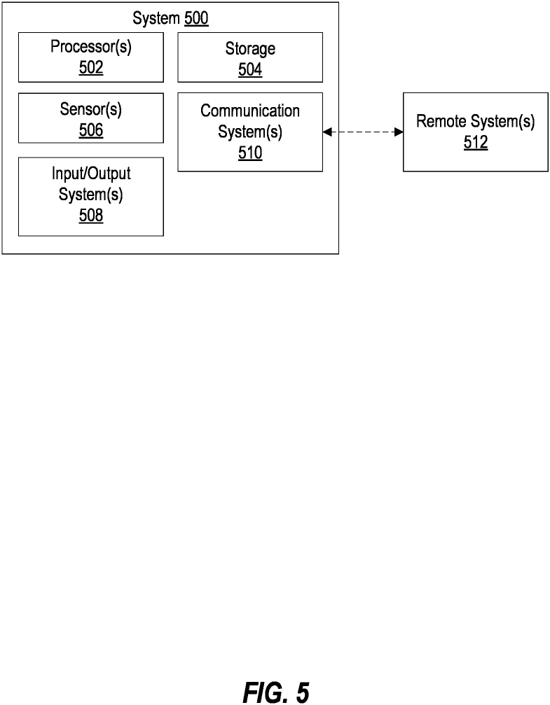

FIG. 5 illustrates example components of a system 500 that may comprise or implement aspects of one or more disclosed embodiments. For example, FIG. 5 illustrates an implementation in which the system 500 includes processor(s) 502, storage 504, sensor(s) 506, I/O system(s) 508, and communication system(s) 510. Although FIG. 5 illustrates a system 500 as including particular components, one will appreciate, in view of the present disclosure, that a system 500 may comprise any number of additional or alternative components.

The processor(s) 502 may comprise one or more sets of electronic circuitries that include any number of logic units, registers, and/or control units to facilitate the execution of computer-readable instructions (e.g., instructions that form a computer program). Such computer-readable instructions may be stored within storage 504. The storage 504 may comprise physical system memory and may be volatile, non-volatile, or some combination thereof. Furthermore, storage 504 may comprise local storage, remote storage (e.g., accessible via communication system(s) 510 or otherwise), or some combination thereof. Additional details related to processors (e.g., processor(s) 502) and computer storage media (e.g., storage 504) will be provided hereinafter.

As will be described in more detail, the processor(s) 502 may be configured to execute instructions stored within storage 504 to perform certain actions. In some instances, the actions may rely at least in part on communication system(s) 510 for receiving data from remote system(s) 512, which may include, for example, separate systems or computing devices, sensors, and/or others. The communications system(s) 510 may comprise any combination of software or hardware components that are operable to facilitate communication between on-system components/devices and/or with off-system components/devices. For example, the communications system(s) 510 may comprise ports, buses, or other physical connection apparatuses for communicating with other devices/components. Additionally, or alternatively, the communications system(s) 510 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 5 illustrates that a system 500 may comprise or be in communication with sensor(s) 506. Sensor(s) 506 may comprise any device for capturing or measuring data representative of perceivable phenomenon. By way of non-limiting example, the sensor(s) 506 may comprise one or more image sensors, microphones, thermometers, barometers, magnetometers, accelerometers, gyroscopes, and/or others.

Furthermore, FIG. 5 illustrates that a system 500 may comprise or be in communication with I/O system(s) 508. I/O system(s) 508 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, head-mounted displays, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

We claim:

1. A system, comprising:
one or more processors; and
one or more hardware storage devices that store instructions that are executable by the one or more processors to configure the system to:
determine one or more redemption pathways for facilitating redemption of utility for a unique digital asset, the one or more redemption pathways comprising one or more redemption triggers and one or more redemption processes; and
in response to detecting presence or performance of the one or more redemption triggers, facilitate the one or more redemption processes to cause redemption of the utility associated with the unique digital asset.

2. The system of claim 1, wherein the unique digital asset is associated with a digital asset code.

3. The system of claim 2, wherein the one or more redemption pathways are determined based upon a list of digital asset codes that includes the digital asset code.

4. The system of claim 1, wherein the instructions are executable by the one or more processors to configure the system to determine the utility for the unique digital asset.

5. The system of claim 4, wherein the utility is defined by data associated with the unique digital asset in accordance with a predetermined data type definition.

6. The system of claim 4, wherein the one or more redemption pathways are determined based upon the utility for the unique digital asset.

7. The system of claim 1, wherein the one or more redemption pathways are selected from a set of predetermined redemption pathways.

8. The system of claim 1, wherein the one or more redemption pathways comprise a set of inter-linked steps with one or more parent-child relationships among the set of inter-linked steps.

9. The system of claim 8, wherein the one or more redemption triggers comprise one or more root steps of the set of inter-linked steps, and wherein the one or more redemption processes comprise one or more additional steps of the set of inter-linked steps.

10. The system of claim 1, wherein the utility for the unique digital asset comprises providing one or more physical assets, digital assets, services, statuses, abilities, privileges, or states to one or more beneficiaries.

11. The system of claim 10, wherein the one or more beneficiaries comprise one or more owners of the unique digital asset.

12. The system of claim 1, wherein facilitating the one or more redemption processes comprises managing a redemption instance.

13. The system of claim 12, wherein managing the redemption instance comprises communicating the one or more redemption processes to one or more entities and/or tracking performance of the one or more redemption processes by the one or more entities.

14. The system of claim 13, wherein the instructions are executable by the one or more processors to configure the system to:
generate, in a minting/transactions queue, one or more records of performance of the one or more redemption processes by the one or more entities; and
initiate minting of the one or more records into one or more decentralized ledgers.

15. The system of claim 14, wherein facilitating the one or more redemption processes and generating the one or more records of performance in the minting/transactions queue is performed using a centralized system that is distinct from a decentralized system configured to mint the one or more records into the one or more decentralized ledgers.

16. The system of claim 1, wherein the unique digital asset comprises a non-fungible token.

17. A system, comprising:
one or more processors; and
one or more hardware storage devices that store instructions that are executable by the one or more processors to configure the system to:
detect performance of one or more redemption processes of one or more redemption pathways for facilitating redemption of utility for a unique digital asset;
generate, in a minting/transactions queue, one or more records of performance of the one or more redemption processes by one or more entities; and
initiate minting of the one or more records into one or more decentralized ledgers.

18. The system of claim 17, wherein detecting the performance of the one or more redemption processes and generating the one or more records of performance in the minting/transactions queue is performed using a centralized system that is distinct from a decentralized system configured to mint the one or more records into the one or more decentralized ledgers.

19. The system of claim 17, wherein the instructions are executable by the one or more processors to configure the system to generate a batch of records of performance of redemption processes associated with utility for a plurality of unique digital assets, wherein the batch of records includes the one or more records of performance, and wherein initiating minting of the one or more records into the one or more decentralized ledgers comprises initiating minting of the batch of records.

20. A method, comprising:
determining one or more redemption pathways for facilitating redemption of utility for a unique digital asset, the one or more redemption pathways comprising one or more redemption triggers and one or more redemption processes; and
in response to detecting presence or performance of the one or more redemption triggers, facilitating the one or more redemption processes to cause redemption of the utility associated with the unique digital asset.
